(19) United States
(12) Patent Application Publication
(10) Pub. No.: US 2020/0022314 A1
(43) Pub. Date: Jan. 23, 2020

(54) SYSTEMS AND METHODS ASSOCIATED WITH GROWING A GOURD

(71) Applicant: Jun Aizaki, Brooklyn, NY (US)

(72) Inventor: Jun Aizaki, Brooklyn, NY (US)

(21) Appl. No.: 16/517,002

(22) Filed: Jul. 19, 2019

Related U.S. Application Data
(60) Provisional application No. 62/700,950, filed on Jul. 20, 2018.

(51) Int. Cl. A01G 7/06

(52) U.S. Cl. CPC A01G 7/06; A01G 22/00

(57) ABSTRACT

A process to create a container from a gourd that includes a hollow internal chamber.

### BACKGROUND INFORMATION

### Field of the Disclosure

Examples of the present disclosure are related to systems and methods for growing a gourd. More specifically, embodiments are related to a process to create a container that includes a hollow internal chamber.

### Background

Plant training is the practice of controlling plant growth for the production of fruit, controlling the shape of the plant, etc. Plant training is conventionally performed by pruning and tying branches of a plant to frames. This allows the branches of the plant to be shaped into formal patterns.

Plant training may be used for a number of different purposes, such as to optimize plant growth, optimize spacing in a grow house, control the shape of the plant, and/or decorative or aesthetic purposes. For example, a restricted form of plant training may include restricting the vertical movement of branches on the same plane, which allows fruit on each of the branches to receive the same amount of sunlight.

Although, conventional methods of plant training are used for aesthetic purposes and/or to increase fruit yield, conventional methods of plant training do not mold the fruit to create a useful article of manufacture.

Accordingly, needs exist for systems and methods of plant training with a mold to grow a gourd into a container, such as a cup, wherein the mold may include multiple sections that are removably coupled to each other.

### SUMMARY

Embodiments described herein disclose systems and methods for restrictive plant growing that enables a gourd to be manufactured into a container, such as a cup, utilizing a mold with multiple parts that are configured to be selectively coupled to each other at multiple locations.

Embodiments may include a plant and a mold.

The plant may be a gourd or any other type of plant, fruit, etc. that is moldable in a growing stage and rigid upon maturity. The plant may be configured to grow into a shape of the mold while growing, and maintain the shape of the mold upon maturity.

The mold may be a device that is configured to be opened and closed to receive the plant. In embodiments, the mold may be comprised of two substantially symmetrical parts that are configured to be coupled together, and house the plant while the plant grows. The mold may include an open top surface, closed bottom surface, sidewalls, groove, and coupling mechanisms.

The open top surface may positioned at a proximal end of the mold, and be configured to allow a root, branch, etc. of the plant to extend away from the mold. This may enable the mold to not completely encompass the plant, such that the plant may receive nutrients from the outside source.

The closed bottom may be positioned at a distal end of the mold, and be configured to not allow the plant to extend past the distal end of the mold. This may be utilized to control, restrict, etc. a vertical height of the plant.

The sidewalls may be configured to extend from the closed bottom to the groove. In embodiments, the sidewalls may be planar sidewalls that are outwardly angled, which may increase a diameter of a hollow chamber with the mold from the distal end to the proximal end.

The groove may be an indention within the mold at the ends of the sidewalls. The grooves may enable portions of the plant to be positioned within the groove, which may indicate a cutting point to cut and clean a dried gourd. Specifically, the groove may be positioned at a desired height from the open top surface, such that the gourd may be cut along the groove to remove portions of the root, branch, etc. of the fruit that are a sufficient distance from a body of the dried gourd.

The coupling mechanisms may be configured to temporarily couple the first half of the mold with the second half of the mold, such that the mold may encompass the plant. The coupling mechanisms may include a first coupling joints and second coupling joints.

The first coupling joints may be positioned above the groove, wherein the first half includes a first male and female pair and the second half includes a second male and female pair. The first male and female pair may be configured to interface with the second male and female pair. The second coupling joints may be positioned between the closed bottom and the distal end of the mold.

The second coupling joints may include wherein a third male and female pair positioned on the first half and the second half includes a fourth male and female pair. Utilizing the coupling mechanisms the first half and the second half may be able to apply a compressive force against a growing gourd at locations where the gourd could supply sufficient pressure to decouple the first half and the second half. In embodiments, the first coupling joints and the second coupling joints may be different shapes to provide different mechanical forces to couple the first half of the mold and the second half of the mold. For example, the first coupling joints may be cylindrical in shape, while the second coupling joints may be oval shaped.

These, and other, aspects of the invention will be better appreciated and understood when considered in conjunction with the following description and the accompanying drawings. The following description, while indicating various embodiments of the invention and numerous specific details thereof, is given by way of illustration and not of limitation. Many substitutions, modifications, additions or rearrangements may be made within the scope of the invention, and the invention includes all such substitutions, modifications, additions or rearrangements.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 depicts a system configured to grow a plant to a desired shape within a mold, according to an embodiment.

FIG. 2 depicts a system configured to grow a plant to a desired shape within a mold, according to an embodiment.

FIG. 3 depicts a system configured to grow a plant to a desired shape within a mold, according to an embodiment.

FIGS. 4 and 5 depict a system configured to grow a plant to a desired shape within a mold, according to an embodiment.

FIG. 6 illustrates a method for plant training using a mold, according to an embodiment.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present disclosure. Also, common but well-understood elements that are useful or necessary in a commercially feasible embodiment are often not depicted in order to facilitate a less obstructed view of these various embodiments of the present disclosure.

### DETAILED DESCRIPTION

In the following description, numerous specific details are set forth in order to provide a thorough understanding of the present embodiments. It will be apparent, however, to one having ordinary skill in the art that the specific detail need not be employed to practice the present embodiments. In other instances, well-known materials or methods have not been described in detail in order to avoid obscuring the present embodiments.

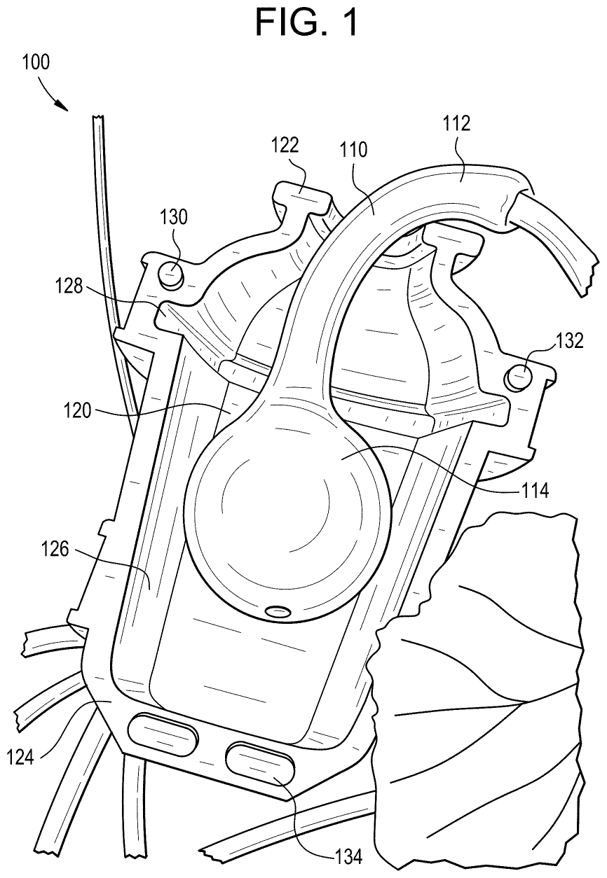

FIG. 1 depicts a system 100 configured to grow a plant 110 to a desired shape within a mold 120, according to an embodiment.

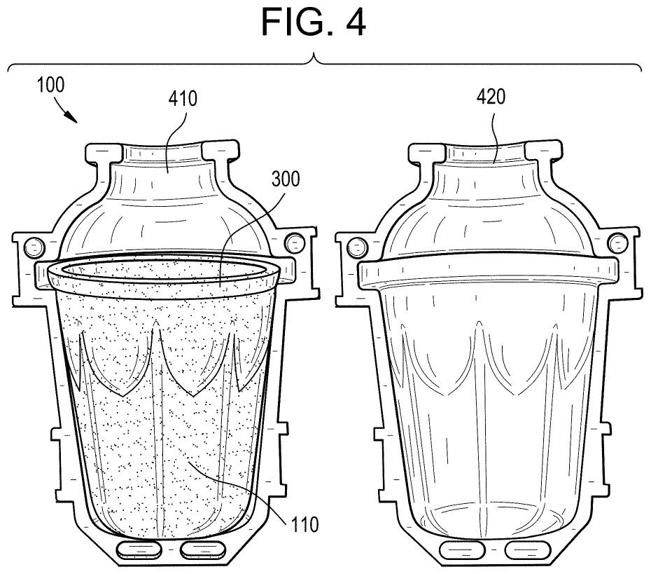

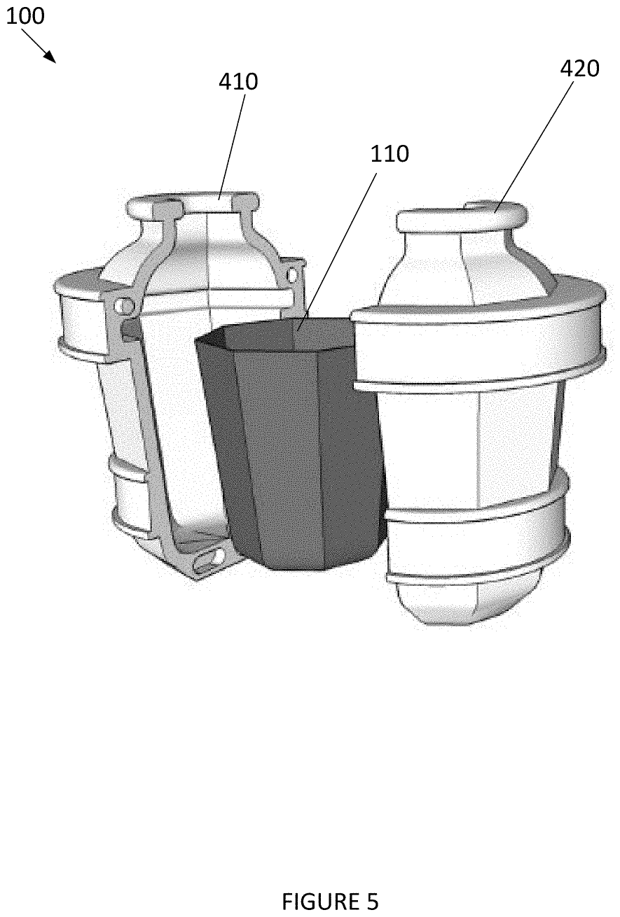

System 100 may include plant 110 and a first half of a mold 120. Embodiments may also include a second half (as shown in FIGS. 4 and 5) of a mold 120, which may be symmetrical to that of the first half.

Plant 110 may be a gourd or any other type of plant, fruit, etc. that is moldable in a growing stage and rigid upon maturity. Plant 110 may be configured to grow into a shape of the mold while growing, and maintain the shape of the mold upon maturity. Plant 110 may include a stem 112 that is configured to be coupled to roots of the plant, wherein plant 110 may receive nutrients through stem 112. Stem 112 may be configured to extend from an area within mold 120 to an area outside of mold 120. Plant may also include a body 114, wherein as plant 110 receives nutrients body 114 may grow.

Mold 120 may be a device that is configured to encompass body 114 of plant 110 when in a closed position, and allow plant 110 to be removed from mold 120 when in an open position. Mold 120 may be comprised of two substantially symmetrical halves that are configured to be coupled together to house portions of plant 110. Mold 120 may include an open top surface 122, a closed bottom surface 124, sidewalls 126, groove 128, and coupling mechanisms 130.

Open top surface 122 may positioned at a proximal end of the mold 120. Open top surface 122 may be configured to allow a root 112 of the plant to extend 110 away from mold 120 while a body 114 of plant 110 remains within mold 120. Open top surface 122 may have a first diameter, which is large enough to allow body 114 to receive sufficient nutrients to fill up a hollow chamber within mold 120, while also being small enough to limit the overall growth of body 114.

Closed bottom 124 may be positioned at a distal end of mold 120. Closed bottom 124 may be configured restrict the expansion of body 114 past the distal end of mold 120. This may be utilized to control, restrict, etc. a vertical height of the plant 120. Furthermore, closed bottom 126 may have a planar bottom surface that is in parallel to open top surface 122, which may cause body 114 to have a planar bottom surface. In embodiments, closed bottom 124 may have a second diameter that is larger than that of open top surface 122.

Sidewalls 126 may be configured to extend from closed bottom 124 to groove 128. In embodiments, sidewalls 126 may be planar sidewalls that are outwardly tapered, which may gradually increase an inner diameter of a hollow chamber with mold 120 from the distal end to the proximal end. Sidewalls 126 may taper to form a hollow cavity within mold 120.

Groove 128 may be positioned on a proximal end of sidewalls 126, may have a third inner diameter. The third inner diameter may be greater than that of the first and second inner diameter. Groove 128 may be an indentation within mold 120 that enables body 114 to be positioned within groove 128 that increases the inner diameter of mold 120. Groove 128 may be configured to create a cutting point to cut and clean a dried gourd 110 without having any further user interaction. Specifically, groove 128 may be positioned a vertical distance from open first end 122 that is sufficiently far enough to remove portions of root, branch, etc. of fruit that have weak or frail outer surfaces. The vertical distance may also be sufficiently small enough to allow body 114 to grow to a sufficient height. In embodiments, groove 128 may be positioned closer to the proximal end of mold 120 than the distal end of mold 120.

Coupling mechanisms 130 may be projections and corresponding indentations that are confirmed to interface with each other. Coupling mechanisms 130 may be utilized to couple the first half of mold 120 with a second half of mold 120 to form a sealed mold 120. First half 130 may include first coupling joints 132 and second coupling joints 134.

First coupling joints 132 may be positioned above the groove 128, wherein the first half includes a first male and female pair and the second half includes a second male and female pair. The first male and female pair may be configured to interface with the second male and female pair.

Second coupling joints 134 may be positioned between the closed bottom and the distal end of the mold. The second coupling joints may include wherein a third male and female pair positioned on the first half and the second half includes a fourth male and female pair. Utilizing coupling mechanisms 130, the first half and the second half may be able to apply a compressive forces against a growing gourd at locations where the gourd could supply sufficient pressure to decouple the first half and the second half. Therefore, it is necessary for coupling mechanisms 130 to be positioned above groove 132 and below closed bottom 130. In embodiments, first coupling joints 132 may be a different size and/or shape than second coupling joints 134. This may enable first coupling joints 132 and second coupling joints 134 to apply a different amount of compressive forces against gourd 110. This may enable second coupling joints 134 to apply more compressive forces against gourd 110 than first coupling joint 132. This may due to the expansive forces of gourd 110 against the inner diameter of mold 120 being greater below groove 128 than above groove 128.

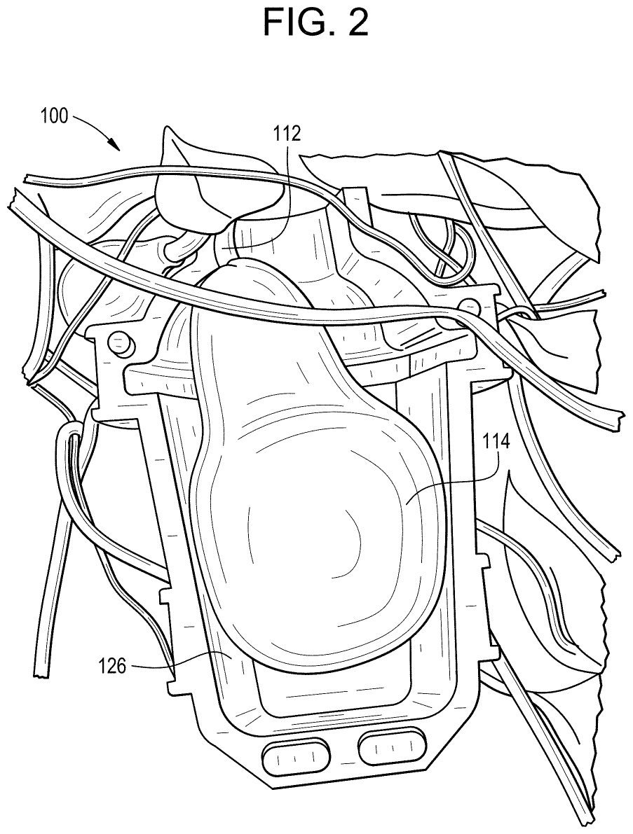

FIG. 2 depicts system 100, according to an embodiment. As depicted in FIG. 2, plant 110 may continue to grow within mold 120. However, the growth of body 114 may be restricted and controlled by sidewalls 126. Further, the growth of body 114 may be enabled by allowing root 112 to extend out through the open top surface 122.

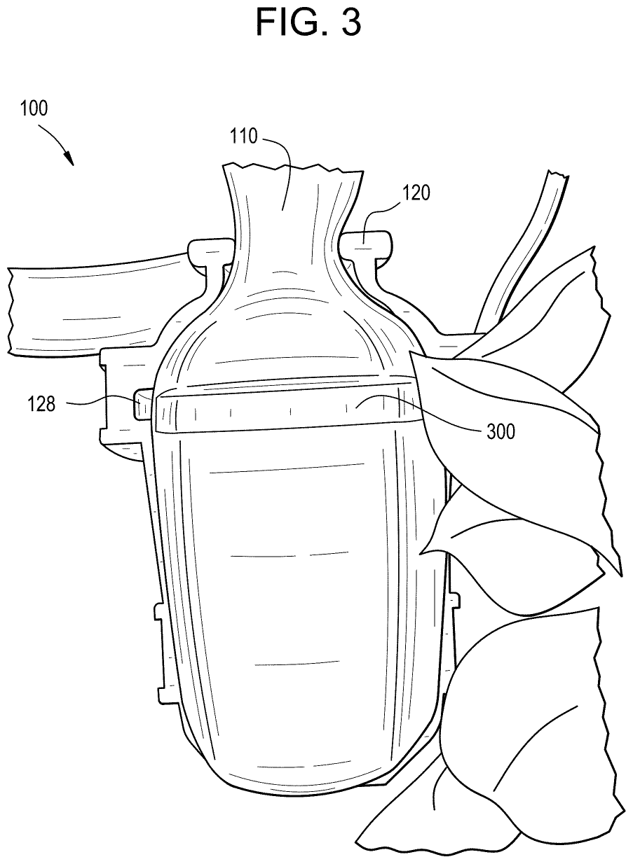

FIG. 3 depicts system 100, according to an embodiment. As depicted in FIG. 3, plant 110 may grow to be substantially the same size as that as the hollow chamber within mold 120. More so, plant 110 may grow to have a rim 300 that correspond with the location and depth of groove 128. Rim 300 may be utilized as a benchmark to cut a dried and mature plant 110.

FIGS. 4 and 5 depict system 100, according to an embodiment. As depicted in FIGS. 4 and 5, mold 120 may include two symmetrical halves 410 and 420, which are configured to be coupled together to create a hollow chamber. As further depicted, responsive to growing plant 110, and upper surface of plant 110 may be cut along the projection line. This may enable plant 110 to have a body with rigid sidewalls and allow the body of the rigid body to be cut. This may form a rigid container.

In embodiments, mold 120 may have manufactured internal dimensions and sidewalls that allows plants 110 that are cut to be stacked on top of each other once plant 110 has been hollowed out. This allows the resulting dried and matured plant to have utilitarian uses, such as a stackable container.

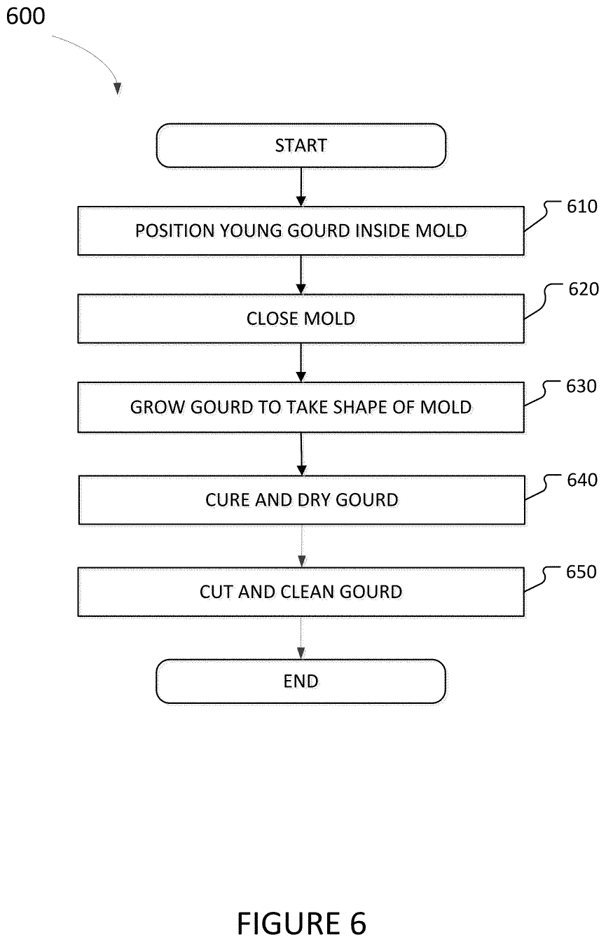

FIG. 6 illustrates a method 600 for plant training using a mold. The operations of method 600 presented below are intended to be illustrative. In some embodiments, method 600 may be accomplished with one or more additional operations not described, and/or without one or more of the operations discussed. Additionally, the order in which the operations of method 600 are illustrated in FIG. 6 and described below is not intended to be limiting.

At operation 610, a young gourd may be positioned inside an open mold.

At operation 620, the mold may be closed by securing two portions of the mold together.

At operation 630, the gourd may grow inside of the mold and take shape of a hollow chamber between the two sections of the mold.

At operation 640, the two sections of the mold may be separated from each other, and the gourd may be cured and dried.

At operation 650, the dried gourd may be cut along a rim extending a circumference of the gourd, wherein the rim has a greater circumference than the rest of the gourd.

Additionally, any examples or illustrations given herein are not to be regarded in any way as restrictions on, limits to, or express definitions of any term or terms with which they are utilized. Instead, these examples or illustrations are to be regarded as being described with respect to one particular embodiment and as being illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Language designating such nonlimiting examples and illustrations includes, but is not limited to: “for example,” “for instance,” “e.g.,” and “in one embodiment.”

Reference throughout this specification to “one embodiment,” “an embodiment” “one example,” or “an example” means that a particular feature, structure or characteristic described in connection with the embodiment or example is included in at least one embodiment of the present embodiments. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

As used herein, the terms “comprises,” “comprising,” “includes,” “including,” “has,” “having,” or any other variation thereof, are intended to cover a non-exclusive inclusion. For example, a process, article, or apparatus that comprises a list of elements is not necessarily limited to only those elements but may include other elements not expressly listed or inherent to such process, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

What is claimed is:

1. A system for plant training comprising:
a first half of a mold including a closed first distal end and an open first proximal end, a first portion of a groove positioned within a inner diameter of the mold, first coupling joints, and second coupling joints, wherein the first coupling joints and the second coupling joints are different shapes;
a second half of a mold including a closed second distal end and an open second proximal end, a second portion of the groove positioned within an inner diameter of the mold, third coupling joints, and fourth coupling joints, wherein the first coupling joints are configured to interface with the third coupling joints, and the third coupling joints are configured to interface with the fourth coupling joints.

2. The system of claim 1, wherein the first half of the mold and the second half of the mold are configured to be coupled together to form a hollow chamber.

3. The system of claim 2, wherein the first open proximal end and the second open proximal end are configured to be aligned with each other to form a mold open end.

4. The system of claim 3, further including:
a gourd with a body and a stem, wherein the body of the gourd is configured to be positioned within the hollow chamber and the stem is configured to extend from the body of the gourd through the mold open end.

5. The system of claim 4, wherein the groove increases the inner diameter of the hollow chamber of the mold.

6. The system of 5, wherein the gourd grows to the same shape of the hollow chamber of the mold.

7. The system of claim 6, wherein a rim of the gourd is formed along a portion of the gourd corresponding to the groove, wherein the gourd is configured to be cut along the rim.

8. The system of claim 1, wherein the first coupling joints are positioned above the first portion of the groove, and the second coupling joints are positioned below the groove.

9. The system of claim 8, wherein the second coupling joints are larger than the first coupling joints.

10. The system of claim 9, wherein the first coupling joints a cylindrical in shape and the second coupling joints are oblong in shape.

11. A method for plant training comprising:
positioning a gourd within a first half of a mold, the first half of the mold including a closed first distal end and an open first proximal end, a first portion of a groove positioned within a inner diameter of the mold, first coupling joints, and second coupling joints, wherein the first coupling joints and the second coupling joints are different shapes;
coupling a second half of the mold with the first half of the mold, the second half of a mold including a closed second distal end and an open second proximal end, a second portion of the groove positioned within an inner diameter of the mold, third coupling joints, and fourth coupling joints, wherein the first half of the mold and the second half of the mold are coupled together by interfacing first coupling joints with the third coupling joints and the third coupling joints with the fourth coupling joints.

12. The method of claim 11, further comprising:
forming a hollow chamber within the mold when the first half of the mold and the second half of the mold are coupled together.

13. The method of claim 12, further comprising:
aligning the first open proximal end and the second open proximal end to form a mold open end.

14. The method of claim 13, wherein a body of the gourd is positioned within the hollow chamber and a stem of the gourd extends from the body of the gourd through the mold open end.

15. The method of claim 14, wherein the groove increases the inner diameter of the hollow chamber of the mold.

16. The method of claim 15, further comprising:
growing the gourd to the same shape of the hollow chamber of the mold.

17. The method of claim 16, further comprising:
forming a rim of the gourd along a portion of the gourd corresponding to the groove;
cutting the gourd along the rim.

18. The method of claim 11, wherein the first coupling joints are positioned above the first portion of the groove, and the second coupling joints are positioned below the groove.

19. The method of claim 18, wherein the second coupling joints are larger than the first coupling joints.

20. The method of claim 19, wherein the first coupling joints a cylindrical in shape and the second coupling joints are oblong in shape.
